(19) United States
(12) Patent Application Publication
(10) Pub. No.: US 2007/0034338 A1
(43) Pub. Date: Feb. 15, 2007

(54) Binding apparatus for binding both ends of an adhesive tape around an object

(76) Inventor: Hisashi Ogawa, Tokyo (JP)

Correspondence Address: WEISS & MOY PC, 4204 NORTH BROWN AVENUE, SCOTTSDALE, AZ, 85251, US

(21) Appl. No.: 11/200,316

(22) Filed: Aug. 9, 2005

(51) Int. Cl. B65B 51/06; B29C 63/04

(52) U.S. Cl. 156/468; 156/459; 156/475

(57) ABSTRACT

A binding apparatus for binding both ends of an adhesive tape around an object has a base plate. A tape-retaining member is coupled to the base plate and has a spool onto which the adhesive tape is wound, allowing the spool to turn freely. An opening is located at one end of the base plate that houses the object to be wound. A tape-end processing device holds the adhesive tape from both ends and releases the free end of the adhesive tape. A plate is provided that freely moves in a direct line from the opening in the base plate to the tape-retaining section, and an arm coupled on the plate so that rotates freely. A plate-transfer device is provided for moving the plate in a straight-line direction. An arm-turning device is coupled to the arm to turn the arm. A straight-line position-detection device is provided that detects the position of the plate. A turn position-detection device detects the turning position of the arm. A control device controls the drive of the plate-transfer device and the arm-turning device with signals detected by the straight line position-detection device and the turn position-detection device.

### FIELD OF THE INVENTION

This invention pertains to a binding apparatus and, more specifically, to a binding apparatus that binds objects by winding adhesive tape around the object.

### BACKGROUND OF THE INVENTION

A known method for binding and anchoring branches and vines of such horticultural and agricultural products as grapes, cucumbers, etc., onto splints-and stretched string, etc., includes the use of adhesive vinyl-type tape on the object to be bound with the winding of tape around it and then fastening the ends of the tape with a binding needle or staple. This method, however, creates a major problem in terms of environmental pollution because it leaves behind non-biodegradable vinyl, bonding needles and staples, all of which will remain intact for generations.

Alternatively, there is also a known method of using paper-based adhesive tape to wind the tape around a given object and to bind both ends of the adhesive tape. Using this method it is possible to solve the problem of environmental pollution because no binding needle or staple is used and the tape is made of paper, which is biodegradable. However, in methods using adhesive tape the vines and branches of the objects to be taped are wound with tape that provides some slack because the surface of the tape does not slide. Therefore, the objects are not tightly bound, inviting the problem in which the vines and branches easily become disengaged from the splints. It therefore becomes necessary to bind the vines and branches manually to create a firm bond.

The objective of this invention is to provide a binding apparatus that binds both ends of an adhesive tape around an object by firmly winding the tape around the object without allowing slack and without using binding needles or staples at either end of the tape.

Therefore, a need existed to provide a device and method to overcome the above problem.

### SUMMARY OF THE INVENTION

To achieve the objective as described above, the binding apparatus of this invention consists of the following: The subject invention is an apparatus installed on a base plate, said invention having the following parts and characteristics: A tape-retaining section that contains a spool onto which the adhesive tape is wound, allowing it to turn freely; a section located at one end of the base plate that allows housing the object to be wound from the opening; a tape-end processing device that holds the tape from both ends or releases the free end of the tape located on the aforementioned aperture side from the housing section of the base plate; a plate that freely moves in a direct line from the aforementioned housing section of the base plate to the tape-retaining section, and an arm installed on the plate so that it can rotate freely; a plate-transfer device for moving the plate in a straight-line direction; an arm-turning device for the aforementioned arm to turn; a straight-line position-detection device that detects the position of the aforementioned plate; a turn position-detection device that detects the turning position of the aforementioned arm; a control device that controls the drive of the aforementioned plate-transfer device and the arm-turning device with the signals detected by the aforementioned straight line position-detection device and the aforementioned turn position-detection device.

The aforementioned device is designed to hold the free ends of the tape-end processing device while retaining the midsection of the tape between the free ends of the tape and the tape spool, using the tip section of the arm so that it can slide freely.

The control device drives the plate-transfer device and the arm-turning device, and winds the tape onto the object to be wound with tape stretched taut and by moving the midsection of the tape around the circumference of the object in the housing section, with (both ends of) the tape bound together. The arm then severs the midsection of the tape with the tape-processing device, and the free ends of the severed tape are held by the binding apparatus being characterized.

Because of this set up, the objects to be bound can be secured firmly because of the use of a non-adhesive tape used in a stretched state to wind the tape around the perimeter of the object to be bound.

The present invention is best understood by reference to the following detailed description when read in conjunction with the accompanying drawings.

### BRIEF DESCRIPTION OF THE DRAWINGS

FIG. 1 is a drawing showing the exterior of this invention's embodiment.

FIG. 2 is a drawing that explains the structure and movement of one side of the interior of the embodiment.

FIG. 3 is a drawing that explains the structure and movement of one side of the interior of the embodiment.

FIG. 4 is a drawing that explains the structure and movement of one side of the interior of the embodiment.

FIG. 5 is a drawing that explains the structure and movement of one side of the interior of the embodiment.

FIG. 6 is a drawing that explains the structure and movement of one side of the interior of the embodiment.

FIG. 7 is a drawing that explains the structure and movement of one side of the interior of the embodiment.

FIG. 8 is an expanded drawing that explains the main sections and their movements of the embodiment.

FIG. 9 is an expanded drawing that explains the main sections and their movements of the embodiment.

FIG. 10 is an expanded drawing that explains the main sections and their movements of the embodiment.

FIG. 11 is an expanded drawing that explains the main sections and their movements of the embodiment.

FIG. 12 is an expanded drawing that explains the main sections and their movements of the embodiment.

FIG. 13 is a drawing that explains the structure and movement of the rear side of the interior of the embodiment.

FIG. 14 is a drawing that explains the structure and movement of the rear side of the interior of the embodiment.

FIG. 15 is a drawing that explains the structure and movement of the rear side of the interior of the embodiment.

FIG. 16 is a drawing that explains the structure and movement of the rear side of the interior of the embodiment.

FIG. 17 is a drawing that explains the structure and movement of the rear side of the interior of the embodiment.

FIG. 18 is a drawing that explains the structure and movement of the rear side of the interior of the embodiment.

FIG. 19 is a drawing that explains the structure and movement of the rear side of the interior of the embodiment.

FIG. 20 is a drawing that explains the structure and movement of the rear side of the interior of the embodiment.

FIG. 21 is a drawing that explains the structure and movement of the rear side of the interior of the embodiment.

FIG. 22 is an expanded drawing that explains the main sections and their movements of the embodiment.

FIG. 23 is a block diagram of the embodiment showing the circuit configuration.

Common reference numerals are used throughout the drawings and detailed description to indicate like elements.

### DETAILED DESCRIPTION

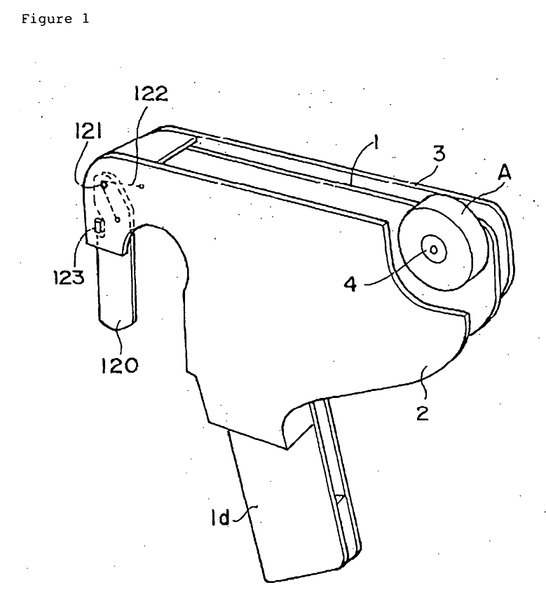

The following illustrates the form of embodiment of this invention of a binding apparatus based on drawings: FIG. 1 shows the rough configuration of one form of the embodiment of this invention. In FIG. 1, cover plates 2 and 3 are fixed parallel to the base plate 1 on both sides of the base plate. A cylindrical bearing 4 for that allows tape A to freely bind an object is located on the upper right-hand corner of the base plate 1 in the surface drawing of the base plate 1.

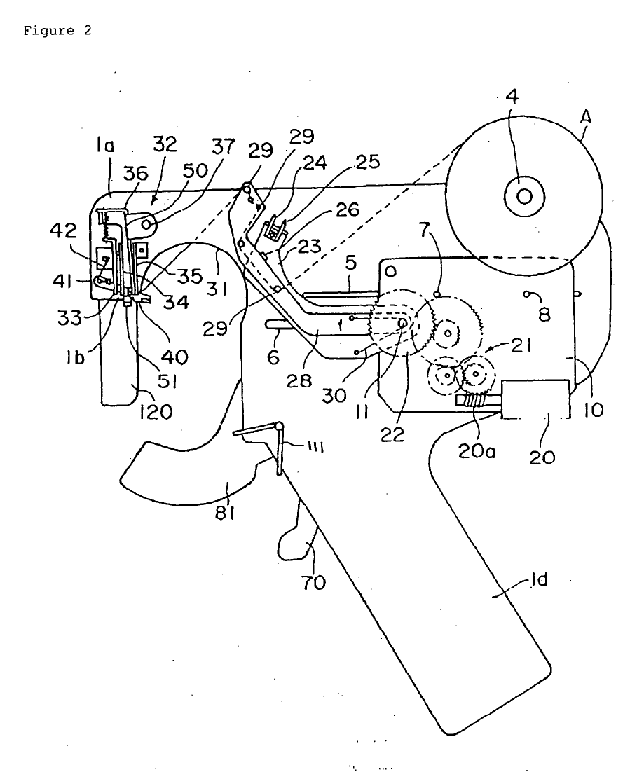

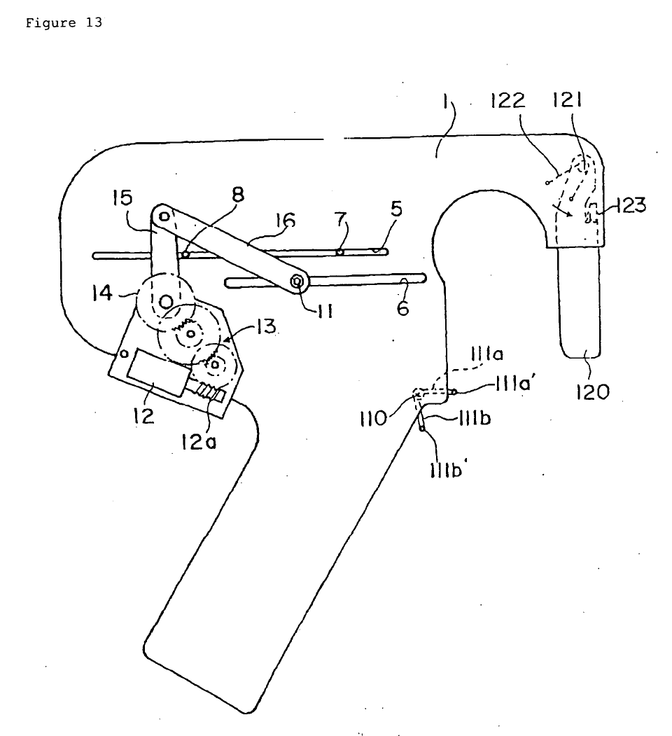

In the wide section below the bearing 4 of the base plate 1, there are two parallel slotted holes 5 and 6 running in the horizontal direction as shown in FIGS. 2 and 13. As shown in FIG. 2, pins 7 and 8, being aligned with slotted hole 5 affix plate 10 so that the plate can slide freely in the horizontal direction on the same side as the bearing 1 on the base plate 1. Additionally, axis 11 is aligned with slotted hole 6 and is attached to plate 10 so that it can turn freely.

As shown in FIG. 13, the plate-transfer device for moving the plate 10 horizontally is installed on the rear surface of the base plate 1. That is, on the back of the base plate 1 are located the motor 12 and the reduction gear device 13, which reduces the revolution of the output axis (worm gear) 12a.

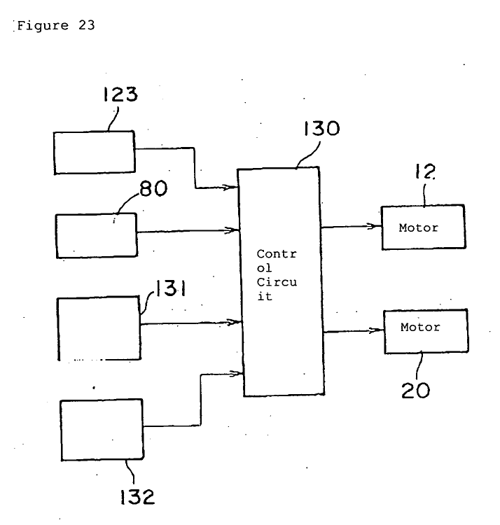

The crank 16 is connected in a way that it freely turns at one end of the crank 15, which turns together with output gear 14, and the end section of crank 16 is attached to axis 11 so that it can turn freely. Therefore, as axis 11 moves along slotted hole 6 according to the revolutions of the motor 12, the plate 10 moves sideways with the axis 11. The position of the axis 11, which moves along slotted hole 6, is sensed by a contact type or a photoelectric-type detection device not shown in the drawing (but shown in FIG. 23 as 131) on the base plate 1. Therefore, the position of plate 10 is sensed in the horizontal direction.

An arm-turning device that moves actuator arm 23 and guide arm 28 is installed on the plate 10. That is, as shown in FIG. 2, the plate 10 has a reduction gear device 21 that reduces the revolutions of the output axis (worm gear) 20a and the motor 20. Additionally, the output gear 22 is attached to axis 11 so that it can turn freely.

The actuator arm 23, which turns in unison with the aforementioned output gear 22, is attached to the axis 11. The insert plate 24 and cutting plate 25 are affixed in parallel to the tip of the actuator arm 23. Moreover, the guide arm 28 is installed on the axis 11, overlapping the actuator arm 23 so that it can turn freely.

Several tape guide rollers 29 are installed on the tip and midsections of the guide arm 28. The guide arm 28 is set to work clockwise (in FIG. 2) via the spring 30 locked onto the arm at one end, and is in contact with the stopper 26 of the actuator arm 23.

The turn angle of the output gear 22 is sensed by the detection device (shown as 132 in FIG. 23), which is attached to the plate 10 but not shown.

The upper-left section of the base plate 1 (in FIG. 2) has a semicircular notch section 31 for housing the object to be bound. Additionally, a tape-processing device 32 for holding both ends of the tape and cutting it is located in the upper left-hand corner 1a.

This tape-processing device 32 is configured in the following way: At the upper corner section la of the base plate 1, flat plates 33 and 34 for cutting are arranged in the vertical direction and mutually parallel in the outside position, while the flat plate 35 for holding the tape in a vertical direction is located on the notch side 31. Additionally, the wedge-action holding (pinch) plate 36 is attached to the upper corner section la by axis 37 so that it can turn freely between the flat plates 34 and 35.

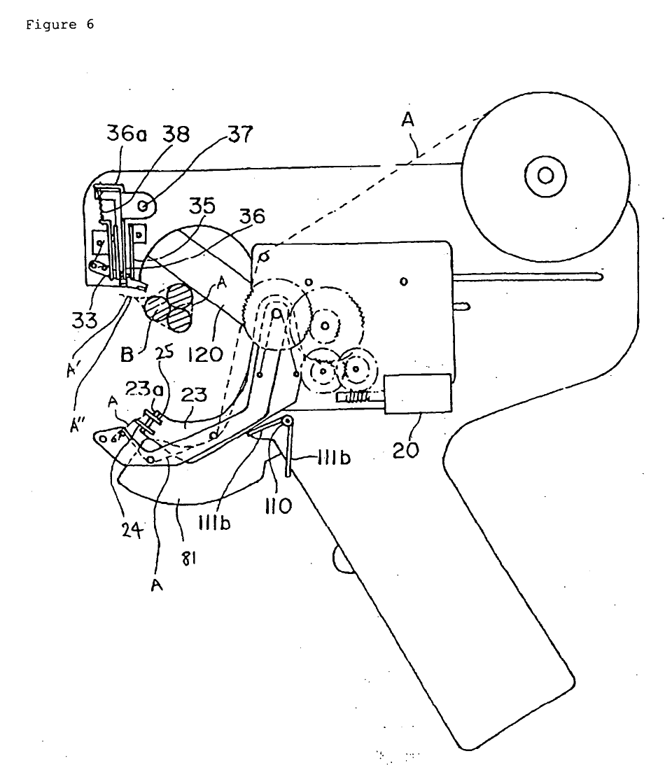

The wedge-action holding (pinch) plate 36, as shown in FIG. 6, has an L-shaped bent section 36a as an extension, and a spring 38 is attached between this bent section 36 and the flat plate 33. Therefore, the wedge-action holding (pinch) plate 36 is set to move counter-clockwise (in FIG. 6), centering on support axis 37. As FIGS. 2 to 4 and FIG. 12 show, the tip 36b of the wedge-action holding (pinch) plate 36 is in flush contact with the tip section 35a of the flat plate 35.

As FIGS. 2, 11 and 12 show, the turning material 40 is attached so that it can freely turn with the aid of the axis 41 installed on the base plate 1 at the lower tip (base plate 1 side) of the flat plates 33, 34 and 35 and the wedge-action holding (pinch) plate 36, and is set to turn clockwise (in FIG. 2) via spring 42.

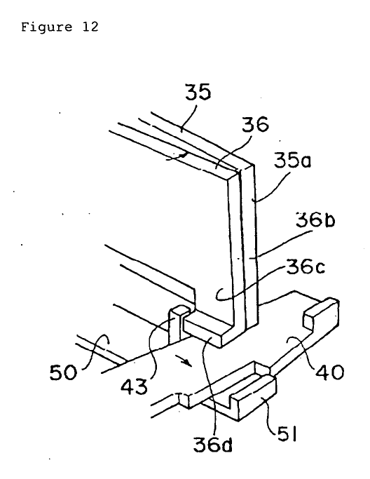

As FIG. 12 shows, the tip 36b of the wedge-action holding (pinch) plate 36 has a protrusion 36c in the direction of the turning material 40. Additionally, this latch protrusion 36d is set in the horizontal direction from the tip of the protrusion section 36c. As FIGS. 2 to 4 and FIG. 12 show, in a situation where the flat plate 35 and the tip of the wedge-action holding plat 36 are in close contact with each other, the protrusion 43 of the turning material 40 which is biased to arrow direction, is in contact with the latch protrusion 36d of the wedge-action holding (pinch) plate 36.

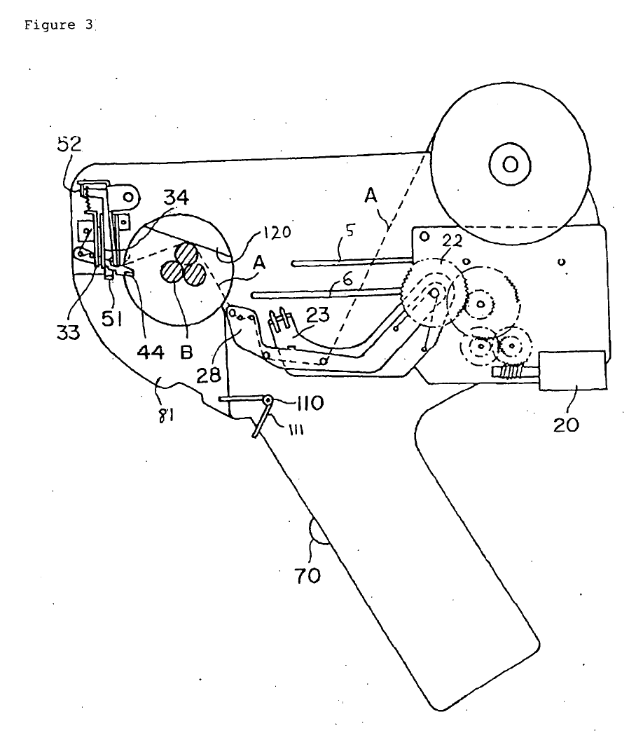

As shown in FIG. 12, the released material 50 is arranged in a vertical direction, with freedom to slide along the base plate 1 between the turning material 40 and the base plate 1. Additionally, its end-protrusion edge section 51 protrudes downward from the bottom side edge section 1b in the horizontal direction of the upper corner section 1a of the base plate 1, while the other edge contact section 52 (see FIG. 3) is in contact with the bent section 36a of the wedge-action holding (pinch) plate 36.

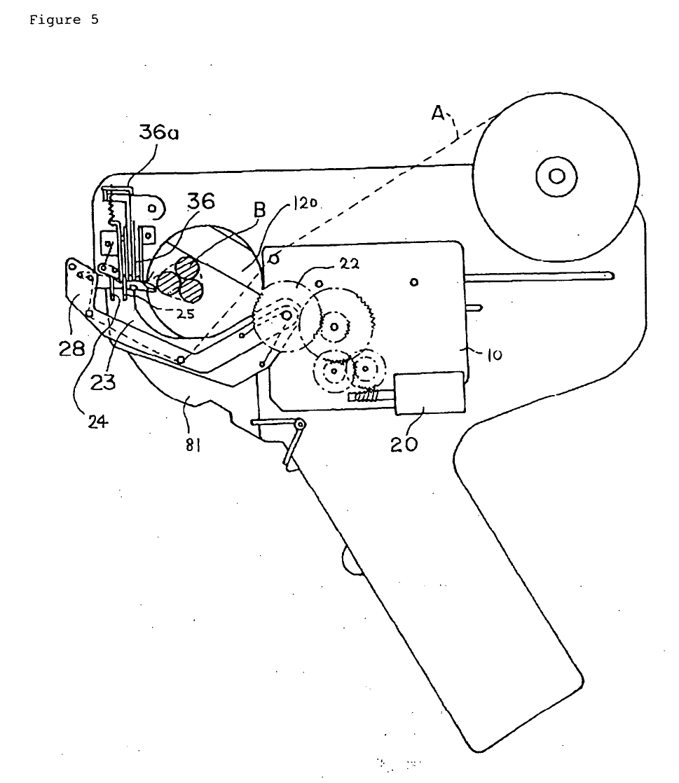

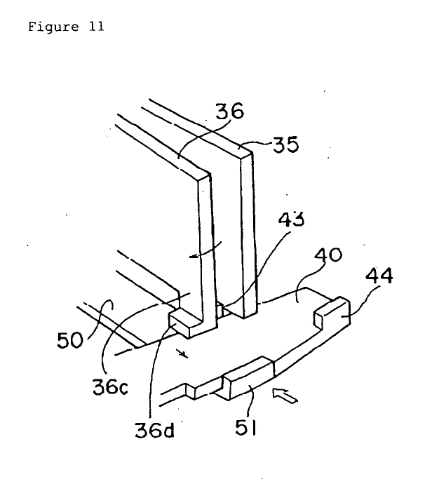

Therefore, when in a state depicted in FIG. 12 the tip edge plate 23a of the actuator arm 23 is used to insert the protrusion section 51 in the direction of the arrow shown in FIG. 11. As shown in FIG. 5, the contact section 52 of the other end of the release section material 50 will push and insert the bent section 36a upward. Therefore, the wedge-action holding (pinch) plate 36 will resist the set force of the spring 38 and turn clockwise as shown in FIGS. 5 and 11.

Accordingly, the protrusion 43 of the turn section material 40 is released from the latch protrusion 36d, and the turn section material 40 will turn in the direction of the arrow (FIG. 11) by the force set by the spring 42, coming into contact with the protrusion edge section 51. In this state the protrusion 43 is in contact with the rear side of the protrusion section 36c of the wedge-action holding (pinch) plate 36. Therefore, the actuator arm 23 becomes detached toward the lower side as shown in FIG. 6, preventing the wedge-action holding (pinch) plate 36 from returning to its original position even if there is no push in the arrow direction as shown in FIG. 11, maintaining a state whereby a gap remains with flat plate 35.

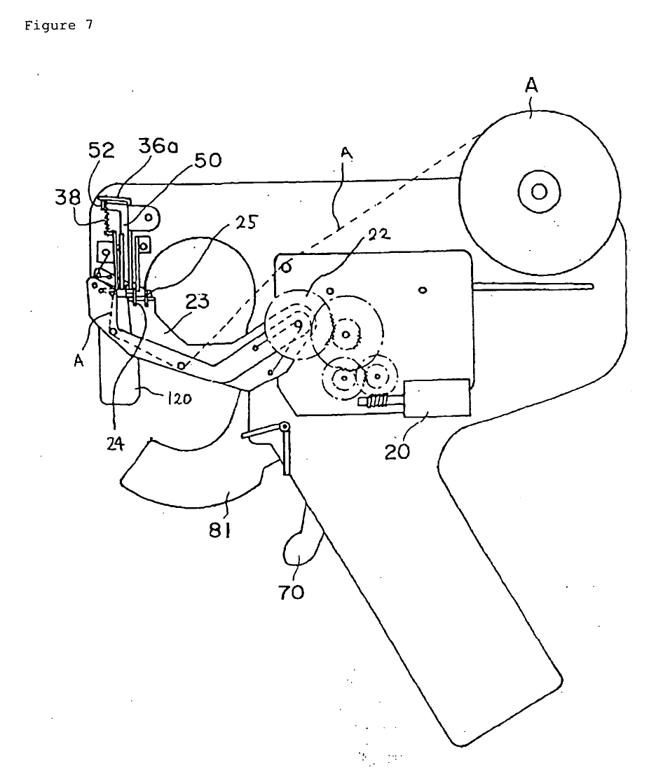

As FIG. 7 shows, when the tip-protrusion section 44 of the turn section material 40 is pushed in with the tip edge plate 23a of the actuator arm 23 in the state depicted in FIG. 11, the wedge-action holding plate returns to its original position under the force set by the spring 38, whereupon it becomes closed as shown in FIG. 12 because the protrusion 43 will proceed beyond (in FIG. 11) the protrusion section 36c of the wedge-action holding (pinch) plate 36 and be released from the protrusion section 36c.

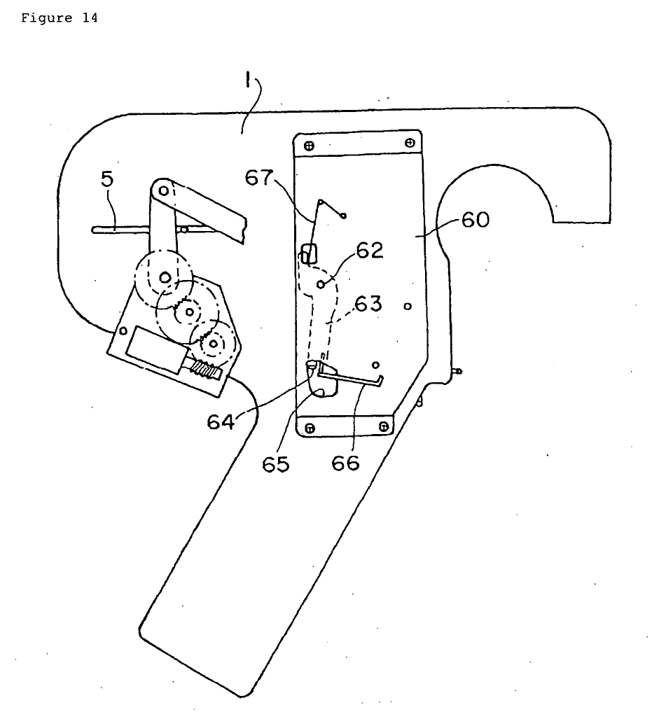

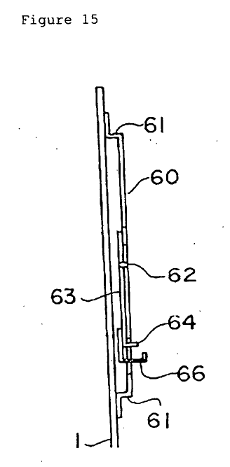

As FIGS. 14 and 15 show, a foot section 61 and a base unit incorporating the foot section are installed at the rear of the base plate 1 parallel with the base plate 1. On the rear surface of the base 60, the work section material 63 is attached with axis 62, allowing it to turn freely. A lever latch unit 64 located at one end of work section material 63 protrudes from the hole 65 in the base unit to the upper surface of the base unit 60.

Additionally, a work bar 66 is fixed to the work section material 63 in a way that it protrudes from the hole 65 to the upper surface of the base unit 60. The work section material 63 is set to turn counter-clockwise (in FIG. 14), centering on the axis 62 via the spring 67.

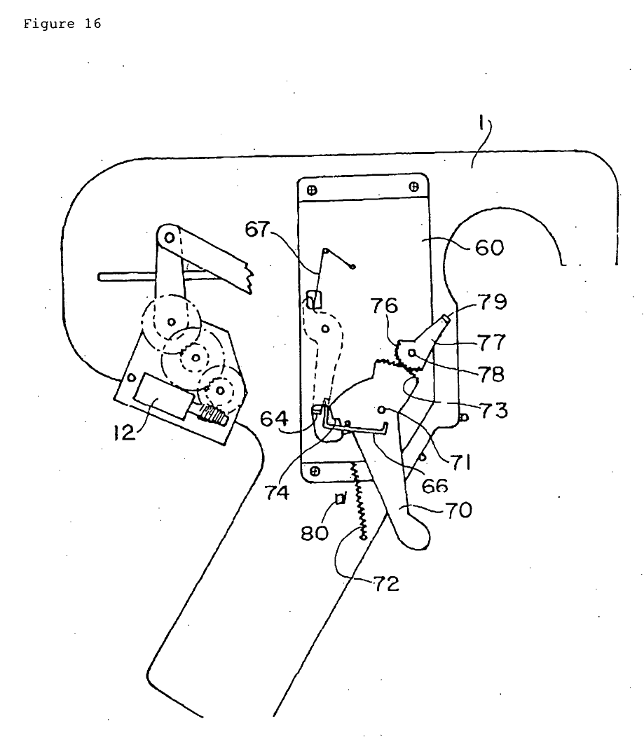

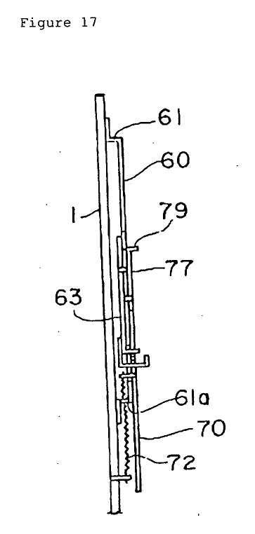

As shown in FIGS. 16 and 17, the operation lever 70 is fastened onto axis 71 so that it can turn freely in close proximity to the upper surface of the base unit 60. (The work bar 66 is close against the upper surface of operating lever 70.) The operating lever 70 is biased to move counter-clockwise (in FIG. 16) by the spring 72 (part of the spring being located on the rear side of the base unit 60 via the hole 61a on the foot section 61).

A gear section 73 is set up along an arc on the upper part of the operation lever 70 and centering on axis 71. Additionally, there is a notch 74 where the lever latch unit 64 of the work section material 63 can be fitted on the operation lever 70.

A rotor 77 with a gear section 76 that fits with the aforementioned gear section 73 is attached so that it can freely turn on the axis 78 close to the upper surface of the base unit 60. A protruding piece 79 is set vertically at one end of the rotor 77. At the rear of the base plate 1, a detector 80 is set so that the operation lever comes in contact with the detector when it is operated as shown in FIG. 21.

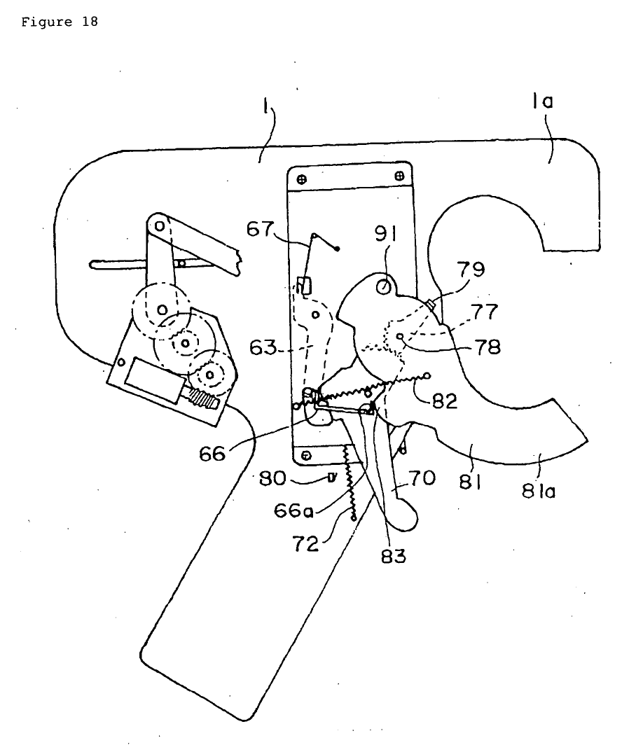

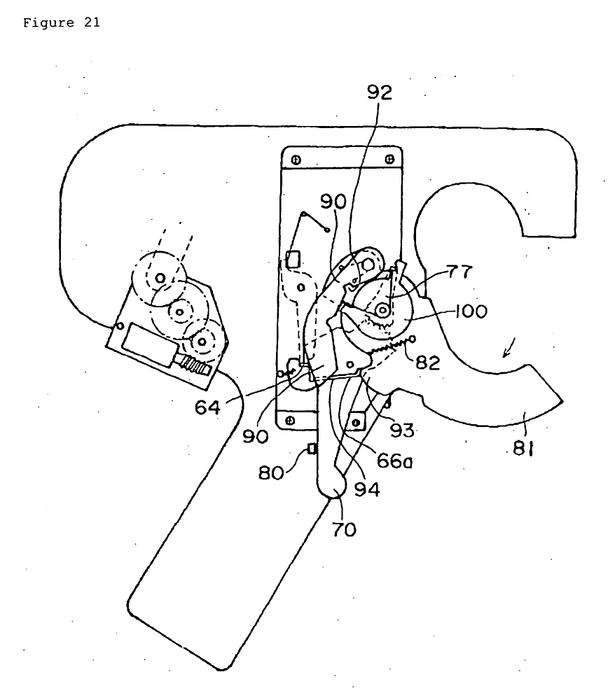

As shown in FIG. 18, a shutter 81 is attached to the base unit 60 so that it can freely turn on the same axis 78 close to the upper surface of the rotor 77. The end section of the shutter 81 is in an arc shape 81a so that it can create a circular space with the notch 31 of the base plate 1 when the shutter is closed as shown in FIG. 20.

The shutter 81 is set by the spring 82 to turn clockwise (in FIG. 18), and pushes the work section material 66 in the clockwise direction while opposing the force of the spring 67 as the corner section 83 comes in contact with the bent tip section 66a of the work bar 66.

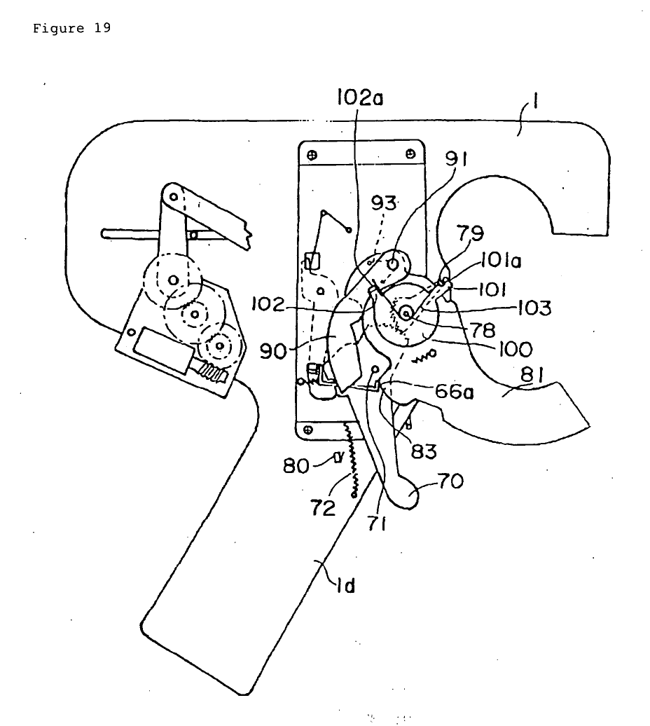

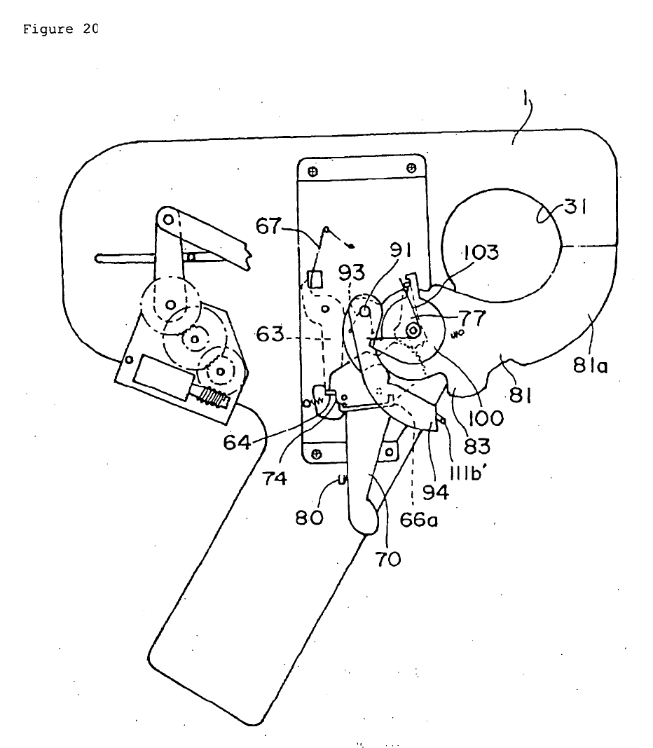

As shown in FIG. 19, an arc-shaped plate 90 equipped with an approximately arc-shaped catch cavity 92 (see FIG. 21) is attached to the opposite side of the arc-shaped section 81a of the shutter 81 so that it can freely turn on axis 91. This arc-shaped plate 90 is biased to turn counter-clockwise (in FIG. 19) around the axis 91 via the force of the spring 93.

Additionally, on the upper surface of the shutter 81 is attached a disk that can turn freely around the axis 78. The disk 100 has a tongue 101 extending in the direction of the radius. Additionally, a notch 101a that couples with protrusion piece 79 of the rotor 77 is located on one side of the tongue 101.

Additionally, on another location of the disk 100 in the direction of the circumference is an extension, being an ear-like protrusion 102 set in the direction of the radius and designed to fit with the catch cavity 92 of the aforementioned arc-shaped plate 90. Additionally, there is a protrusion 102a protruding vertically from the ear-shaped piece 102. Through the spring 103, the protrusion 79 of the toe rotor 77 and the protrusion 102a are biased to move away in the direction of the circumference.

As shown in FIG. 19, when the shutter 81 is opened, the ear-shaped piece 102 of the disk 100 engages the catch cavity 92 because the arc-shaped plate 90 receives the force from the spring 93 to turn counter-clockwise.

When one holds the handle 1d of the base plate 1 under the situation shown in FIG. 19 and turns the lower end section of the operation lever 70 clockwise in opposition to the force of the spring 72, the rotor 77 turns counter-clockwise (in FIG. 19) with the gears 73 and 76 engaged. This turn force is applied via the spring 103 to the protrusion 102a of the ear-shaped piece 102 of the disk 100, and the force is applied to the arc-shaped plate 90 that is hooked to the ear-shaped piece 102.

The force applied to this arc-shaped plate 90 also acts on the axis 91. Therefore, the shutter 81 turns counter-clockwise on the axis 78 while opposing the force of the spring 82 (simultaneously the rotor 77, disk 100 and arc-shaped plate 90 also turn in an integrated fashion), ending in the state shown in FIG. 20. In the state depicted in FIG. 19, the operation lever 70 will be unable to turn as shown in FIG. 20 because the lever latch part 64 of the lower edge of the work section material 63 engages notch 74 of the operation lever 70 due to the force applied by the spring 67. If the operation lever 70 is unable to turn, the rotor 77 with its gear meshed with that of the lever is also unable to turn.

Even if the user's finger is released from the operation lever 70, the shutter 81 in FIG. 20 remains closed because the ear-shaped piece 102 engages the catch cavity 92 and the rotor 77, and because disk 100 and arc-shaped plate 90 are in a state of integration.

As shown in FIGS. 3, 4, 6, 13 and 20, the pivot pin 111 is set to turn freely on the base plate 1 around the axis 110. As FIG. 13 shows, the pivot pin 111 is divided into sections 111a and 111b, with the tip bent vertically with the bent sections designated as 111a′ and 111b′.

In the FIG. 20 state where the shutter 81 remains closed, bent section 111b′ of the pivot pin 111 is located close to the tip section 94 of the arc-shaped plate 90. Accordingly, and as explained later, the actuator arm 23 turns counter-clockwise (in FIG. 6) once the tape is severed. As shown in FIG. 6, when the pivot pin 111 is pressed, the pin turns around the axis 110 and the bent section 111b′ applies pressure to the tip section 94 of the arc-shaped plate 90.

The arc-shaped plate 90 then turns clockwise (in FIG. 20) around the axis 91 in opposition to the force of the spring 93. Accordingly, the ear-shaped piece 102 of the disk 100 is released from the catch cavity 92 of the arc-shaped plate 90, as shown in FIG. 21.

The rotor 77, whose gears are engaged with those of the operation lever 70, is unable to rotate. Moreover, while the disk 100 engaged with protrusion piece 79 of the rotor 77 it is unable to turn because of the spring 103, the shutter 81 and the arc-shaped plate 90—as attached to shutter 81—turn clockwise as shown in FIG. 21 by the force of the spring 82. The tip of the ear-shaped piece 102 will be in a state of being pressed against the edge surface 90a of the arc-shaped plate 90 by the force of the spring 93.

When the shutter 81 opens, the lever latch unit 64 is released from the notch 74 of the operation lever 70 as the corner section 83 pushes the bent tip section 66 of the work bar unit 66 to the left and then returns to the state shown in FIG. 19 as the operation lever 70 turns counter-clockwise around axis 71 by the force of the spring 72.

Simultaneously, with the counter-clockwise turning of the operation level 70, the rotor 77 (FIG. 16), with its gears engaged with the operation lever 70, rotates in the clockwise direction, and the protrusion 79 of the rotor 77 applies pressure on the tongue piece 101 of the disk 100, causing the disk 100 to turn clockwise. The ear-shaped piece 102 of the disk 100 slides along the edge surface 90a of the arc-shaped plate 90 from the state depicted in FIG. 21 and returns to the state depicted FIG. 19 once it is clamped into the catch cavity 92 of the arc-shaped plate 90.

As shown in FIGS. 1 and 13, a band-shaped gate 120 on the inner, upper end of the cover plate 2 is attached to turn freely on the axis 121, and is set by the spring 122 to close the entrance. Detector 123, which detects turning movements in the direction that pushes inward, is located inside the gate 120.

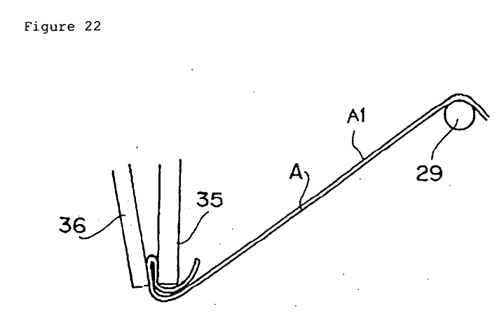

The following explanation will cover the movements of the binding apparatus. As indicated in FIG. 22, for example, if the free end of the adhesive tape A (A1 being the adhesive side) made of paper is held at both ends (to be explained later) from the tip of the wedge-action holding (pinch) plate 36 and the flat plate 35, the user will hold the handle section 1d with his hand and place the object B to be bound within the notch 31 by turning the gate 120 inward after pressing the gate 120 against the object B to be bound in a state where the actuator arm 23 and the guide arm 28 are standing by in the position shown in FIG. 2. The shutter 81 will close as shown in FIGS. 3 and 20, just as explained previously, if the user pulls the trigger of the operation lever 70 with his finger in order to turn the lever.

The turning of the gate 120 is detected by detector 123, while the closing of the shutter 81 by operation lever 70 is detected by detector 80 and the respective detection signals are output to the control circuit 130. The control circuit 130 activates the motors 12 and 20 by sending the drive-control signals to the motors. The plate 10 moves horizontally with the drive of the motor 12, which also drives the gear 22 to turn. The amount of movement of plate 10 is sensed by the detector 131, while the degree to which the gear 22 turns is detected by the detector 132 and the results are sent to the control circuit 130.

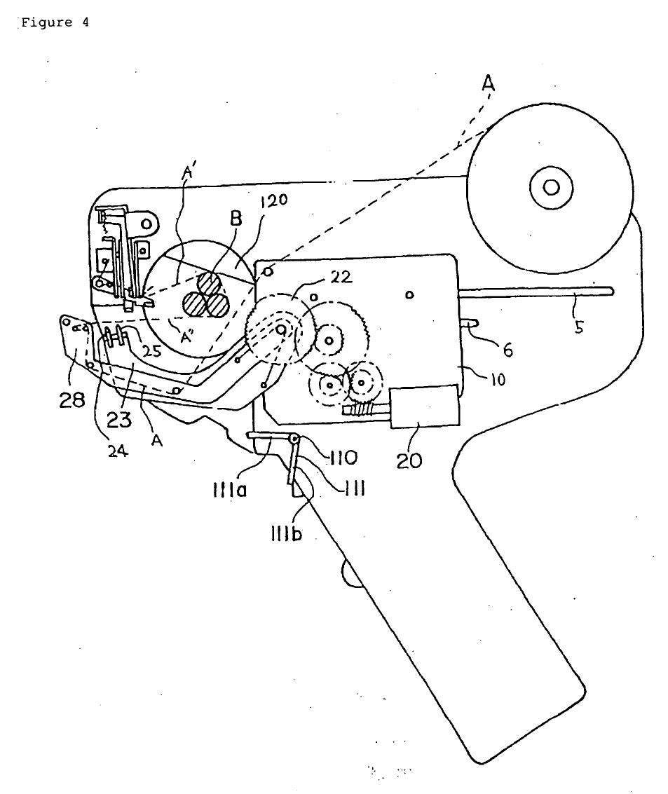

The control circuit 130 sends the drive-control signals to the motors 12 and 20 in accordance with these two detected signals, and then activates the motors as follows: First, the plate 10 is moved from the standby state of FIG. 2 to the right side, while the tips of the actuator arm 23 and guide arm 28 are turned counter-clockwise to go underneath the object B to be bound, as shown in FIG. 3. Next, the arm tips are turned clockwise as shown in FIG. 4 to surround object B to be bound with the adhesive tape A stretched taut. Additionally, Tapes A′ and A″ (shown in FIG. 4) are bonded together as shown in FIG. 5. Thereafter, the cutting plate 25 at the tip of the actuator arm 23 is inserted between flat boards 33 and 34 to sever the tape A.

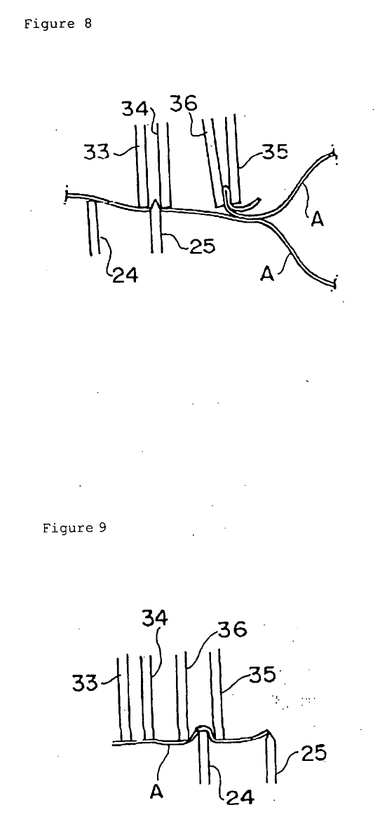

When the tape is cut, the wedge-action holding (pinch) plate 36 (FIG. 8), as explained previously, will detach itself from the flat plate 35 as shown in FIG. 11 and the free end of tape A will be released.

Once the tape is cut, the actuator arm 23 and the guide arm 28 turn counter-clockwise as shown in FIG. 6 to apply pressure on the pivot pin 111. Therefore, the shutter 81 opens, as explained previously, and the operation lever 70 returns to its position. When the user moves the binding apparatus to the right side (in FIG. 6) as if to push out the object B that is bound by the tape A, the gate 120 returns to its position due to the action of the spring 122.

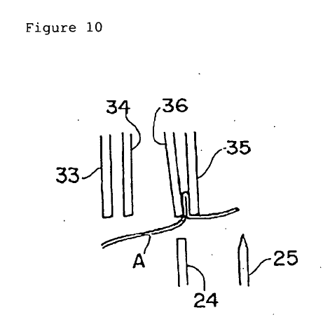

When the shutter 81 opens, detected signals are output to the control circuit 130 from the detector 81. Additionally, when the gate 120 returns to its position, the detector 123 sends the detected signals to the control circuit 130. Accordingly, the control circuit 130 outputs drive-control signals to motors 12 and 20. Therefore, the actuator arm 23 and guide arm 28 turn clockwise as shown in FIG. 7. As shown in FIGS. 7 and 9, the insert plate 24 inserts the end section of the severed tape A between the flat plate 35 and the wedge-action holding (pinch) plate 36. Simultaneously the wedge-action holding (pinch) plate 36 (described previously) returns to its position and, as shown in FIG. 10, holds the end section of the inserted tape A together with the flat plate 35.

Next, the actuator arm 23 and guide arm 28 return to a standby position of FIG. 2. Therefore, the end section of tape A moves to the state shown in FIG. 22 from the state shown in FIG. 10.

In this manner the embodiment of the binding apparatus holds onto the free end of adhesive tape A and wraps the tape around the object B to be bound by moving the tip of the guide arm 28 for guiding the tape A around the periphery of the object B to be bound with the tape A stretched taut, and then binds the tape together. After this, the end section of the tape is severed and the end of the tape A is held. Because the object B to be bound is wrapped in non-adhesive tape A by wrapping the tape around the object B with the tape stretched taut, the object B can be firmly bond with this simple operation.

This disclosure provides exemplary embodiments of the present invention. The scope of the present invention is not limited by these exemplary embodiments. Numerous variations, whether explicitly provided for by the specification or implied by the specification, such as variations in structure, dimension, type of material and manufacturing process may be implemented by one of skill in the art in view of this disclosure.

What is claimed is:

1. A binding apparatus for binding both ends of an adhesive tape around an object comprising:
a base plate;
a tape-retaining member coupled to the base plate and having a spool onto which the adhesive tape is wound, allowing the spool to turn freely;
an opening located at one end of the base plate that houses the object to be wound;
a tape-end processing device that holds the adhesive tape from both ends and releases the free end of the adhesive tape;
a plate that freely moves in a direct line from the opening in the base plate to the tape-retaining section, and an arm coupled on the plate so that rotates freely;
a plate-transfer device for moving the plate in a straight-line direction;
an arm-turning device coupled to the arm to turn the arm;
a straight-line position-detection device that detects the position of the plate;
a turn position-detection device that detects the turning position of the arm; and
a control device that controls the drive of the plate-transfer device and the arm-turning device with signals detected by the straight line position-detection device and the turn position-detection device.
